(19) United States
(12) Patent Application Publication
(10) Pub. No.: US 2010/0223063 A1
(43) Pub. Date: Sep. 2, 2010

(54) Radio Device and Methods of Supplying Same

(76) Inventor: Andrew J. Myatt, Rockmart, GA (US)

Correspondence Address: HARSHAW RESEARCH, INC., 210 W. TECUMSEH STREET, OTTAWA, KS, 66067, US

(21) Appl. No.: 12/394,385

(22) Filed: Feb. 27, 2009

(51) Int. Cl. G06Q 99/00; G01S 1/00

(52) U.S. Cl. 705/1.1; 342/357.09

(57) ABSTRACT

A method of supplying a plurality of radio devices includes obtaining a plurality of radio devices. Each radio device includes a speaker, a satellite radio receiver, a user input, a display, a positioning device, a processor in communication with the speaker, the satellite radio receiver, the user input, the display, and the positioning device, a communication component for communicating with a base unit, the communication device being in communication with the processor. The method includes obtaining a blanket license for the satellite radio receivers. The method includes providing a respective radio device to a user, and deactivating the satellite radio receiver of the respective radio device upon a stop event. Global positioning signal components enable each radio to be tracked and located.

### BACKGROUND OF THE INVENTION

This invention relates generally to radios and, more particularly, to satellite radio devices and methods of supplying them to users along with a temporary satellite radio license during use.

Vacation destinations such as beach side resorts, lake or mountain retreats, or the like often offer to rent beach umbrella's, watercraft such as jet ski's, hiking gear, or other items that enhance a recreation experience Frequently, resort patrons also desire to listen to radios, CD players, and MP3 players while they engage in outdoor recreational activities. To do so, however, usually requires them to bring an appropriate music playing device from home. To have a desired variety of musical styles for an entire day at the beach generally requires the resort patron to bring a large supply of CD's. Alternatively, finding a sufficient variety of musical styles on traditional radio is even more difficult.

Satellite radio has become popular as a means for making a large variety of musical styles and talk show options available to a listener. In addition, satellite radio generally presents superior audio quality. However, a user of satellite radio must first obtain a license or subscription before his satellite radio is enabled to access a satellite radio transmission. Therefore, only licensed users of satellite radio programming who bring their own satellite radios to the resort location are able to enjoy the resort recreational experience along with the superior quality and variety of satellite radio programming. Of course, this is really not feasible at all for persons who travel to the resort location by airplane.

Various proposals have been made in the art for providing satellite radio services and devices. Although assumably effective for their intended purposes, the existing proposals are ineffective for supplying radios to resort patrons along with an appropriate temporary license such that satellite radio signals may be legally accessed by the radio.

Therefore, it would be desirable to have radio devices that are enabled to selectively receive satellite radio transmissions and a method for supplying respective radios to authorized persons. Further, it would be desirable to have a method for supplying a licensed satellite radio to a user and then deactivating and retrieving the radio and providing the respective radio to another user.

### SUMMARY OF THE INVENTION

A method of supplying a plurality of radio devices according to a preferred embodiment of the present invention includes obtaining a plurality of radio devices. Each radio device includes a speaker, a satellite radio receiver, a user input, a display, a positioning device, a processor in communication with the speaker, the satellite radio receiver, the user input, the display, and the positioning device, a communication component for communicating with a base unit, the communication device are in communication with the processor. The method includes obtaining a blanket license for the satellite radio receivers. The method includes providing a respective radio device to a user, and deactivating the satellite radio receiver of the respective radio device upon a stop event. Global positioning signal components enable each radio to be tracked and located.

Therefore, a general object of this invention is to provide a method of supplying a plurality of satellite radio devices to persons on a temporary or rental basis.

Another object of this invention is to provide a satellite radio and method, as aforesaid, that provides a radio to a user for a predetermined or negotiated period of time and then deactivates it until provided to another user.

Still another object of this invention is to provide a satellite radio and method, as aforesaid, in which each radio may be located using a global positioning system.

Yet another object of this invention is to provide a satellite radio and method, as aforesaid, in which the radio that includes a strobe light, iPod interface, and other user controls to enhance the entertainment experience.

A further object of this invention is to provide a satellite radio and method, as aforesaid, in which an umbrella satellite radio license is able to be distributed amongst users of respective satellite radios.

A still further object of this invention is to provide a satellite radio and method, as aforesaid, that enables a resort to make a financial profit by repeatedly renting satellite radios to its patrons.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a satellite radio according to a preferred embodiment of the present invention;

FIG. 2 is a block diagram of the electronic components of the satellite radio as in FIG. 1;

FIG. 3 is a block diagram illustrating a method of supplying satellite radios according to a preferred embodiment of the present invention;

FIG. 4 is a block diagram of the satellite radio controls; and

FIG. 5 is another perspective view of the satellite radio as in FIG. 1 with the cup holders in an extended configuration.

### DESCRIPTION OF THE PREFERRED EMBODIMENT

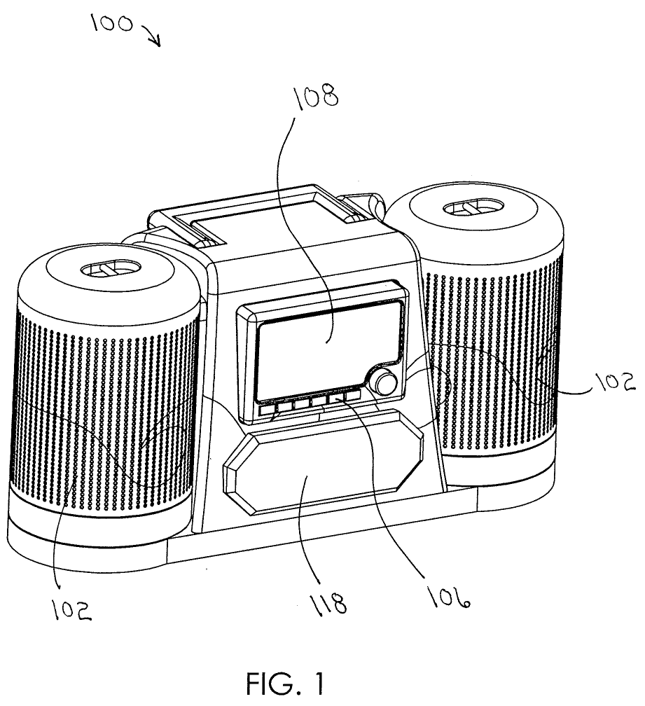

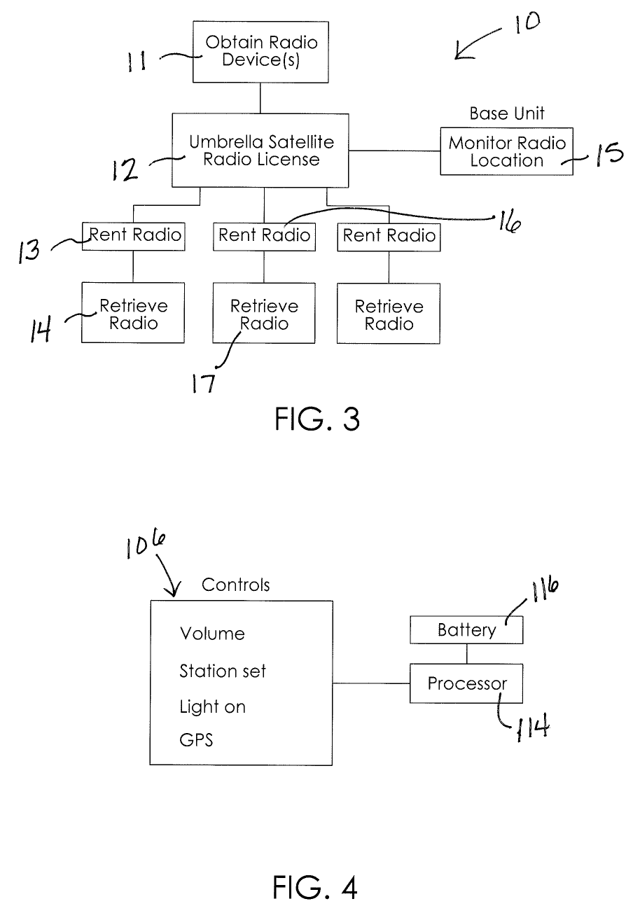

Methods of supplying radio devices according to the present invention will now be described in detail with reference to FIG. 1 through FIG. 5 of the accompanying drawings. The first step 11 of one embodiment 10 (FIG. 3) includes obtaining at least one radio device 100.

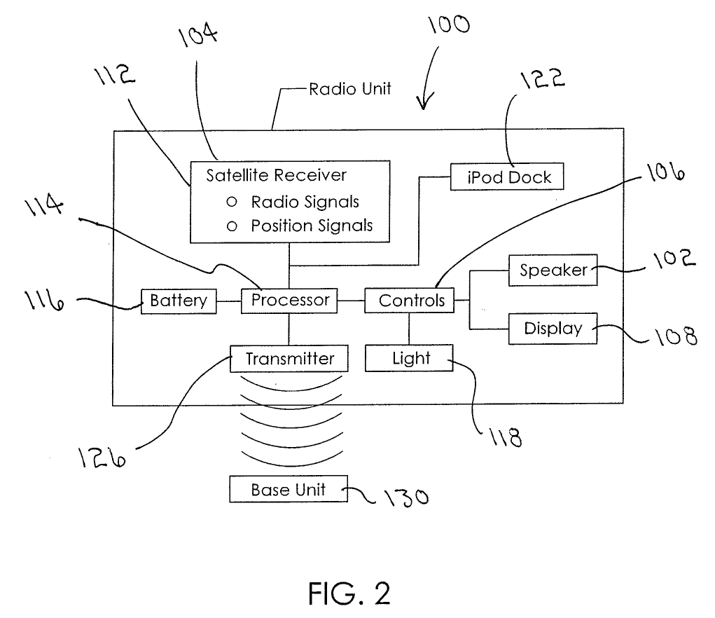

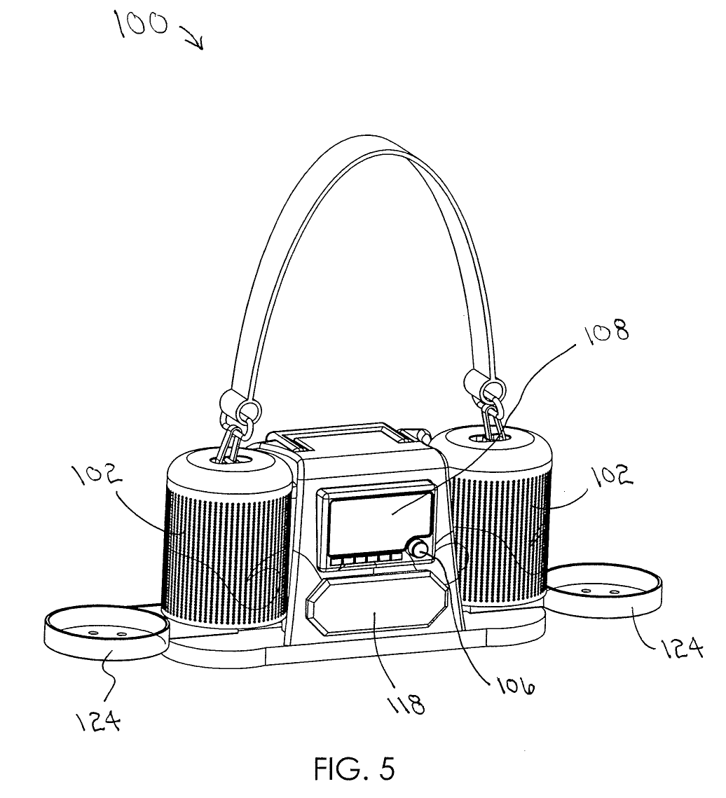

As shown in FIGS. 1 and 2, each radio device 100 may include a speaker 102, a satellite radio receiver 104, a user input 106, a display 108, a positioning device 112 (e.g., a GPS receiver), and a processor 114. The processor 114 is in communication with the speaker 102, the satellite radio receiver 104, the user input 106, the display 108, and the positioning device 112, and a battery 116 may power the processor 114 and the components in communication with the processor 114. The radio devices 100 may further include a light 118 (e.g., a strobe light), an interface 122 for receiving (i.e., being in communication with) a personal music player (e.g., an iPod™), and a fixed or retractable cup holder 124, as shown in FIGS. 2 and 5. The light 118 and/or the interface 122 may be in communication with the processor 114 (FIG. 2). In addition, means 126 may be included for communicating between the processor 114 and a base unit 130, as discussed further below. For example, means 126 may include a transmitter, a receiver, and/or a cable in selective interaction with the base unit 130 and the processor 114.

As shown in FIG. 3, a license for the satellite radio receiver(s) 104 may be required, and such a license may be obtained from a license provider at step 12. If multiple radio devices 100 are included, a blanket license may be obtained. The method proceeds from step 12 to step 13.

At step 13 (FIG. 3), a respective radio device 100 may be provided to a user. The radio device 100 may be provided to the user in exchange for receiving compensation, or in other words, “rented” to the user. In some embodiments, the compensation is based on a rental time (e.g., a number of hours or until a certain point in time), so that a longer rental time requires more compensation than a shorter rental time.

The rental time may be input to the processor 114, for example, using the input 106 or the communicating means 126 and the base unit 130, and the processor 114 may deactivate the satellite radio receiver 104 at the end of the rental time. The processor 114 may also deactivate the satellite radio receiver 104 at the occurrence of other stop events, such as movement of the radio device 100 outside an approved geographical area or the happening of another prohibited condition. The positioning device 112 may provide location information, and the location of the radio device 100 may accordingly be monitored from the base unit 130 (e.g., at step 15 in FIG. 3), or the processor 114 may be provided an approved geographical area and automatically deactivate the satellite radio receiver 104 when the positioning device 112 indicates that the radio device 100 is no longer within the approved geographical area.

After the radio device 100 is provided to a user at step 13, the radio device 100 is retrieved from the user at step 14 (FIG. 3). The user may return the radio device 100, or the radio device 100 may be retrieved by utilizing the positioning device 112. For example, the positioning device 112 may be used to track the location of the radio device 110, and the radio device 100 may therefore be recovered.

Once the radio device 100 is retrieved from the first user, it may be provided to another user at step 16 (FIG. 3) and retrieved again at step 17 (FIG. 3). It should be understood that steps 16 and 17 may generally correspond to the description of steps 13 and 14, and that the radio device 100 may be repeatedly provided and retrieved as set forth in steps 13 and 14.

While a user possesses the radio device 100, he may use the input 106 to enjoy the satellite radio receiver 104 (e.g., by adjusting radio station, volume of the speaker 102, etc.), utilize the GPS device 112, utilize the light 118, and utilize the other features of the radio device 100. However, as set forth above, the satellite radio receiver 104 may be deactivated at the occurrence of a stop event.

It is understood that while certain forms of this invention have been illustrated and described, it is not limited thereto except insofar as such limitations are included in the following claims and allowable functional equivalents thereof.

1-10. (canceled)

11. A method of supplying a radio device, said method comprising the steps of:
(a) obtaining a radio device having:
a speaker;
a satellite radio receiver;
a user input;
a display;
a positioning device;
a processor in communication with said speaker, said satellite radio receiver, said user input, said display, and said positioning device; and
means for communicating with a base unit, said means being in communication with said processor;
(b) obtaining a license for said satellite radio receiver;
(c) providing and activating said radio device to a first user;
(d) automatically deactivating said satellite radio receiver of said radio device upon a first stop event;
(e) retrieving said radio device from said first user;
(f) providing said radio device to a next user;
(g) automatically deactivating said satellite radio receiver of said radio device upon next stop event;
(h) retrieving said radio device from said next user; and
(i) returning to step (f).

12. The method of claim 11, wherein said first stop event is
a time provided to said radio device processor through said base unit and said means for communicating with said base unit.

13. The method of claim 12, wherein said step of retrieving said radio device from said first user includes utilizing said positioning device of said radio device after said first stop event.

14. The method of claim 11, wherein said next stop event is
a time provided to said radio device processor through said base unit and said means for communicating with said base unit.

15. The method of claim 11, wherein:
said step of providing said radio device to said first user is in response to a step of receiving compensation;
said first stop event is a time provided to said radio device processor through said base unit and said means for communicating with said base unit; and
said compensation is proportional to said time.

16. The method of claim 11, wherein said positioning device is a GPS receiver.

17. The method of claim 16, wherein said means for communicating with said base unit includes at least one of a receiver, a transmitter, and a cable in selective interaction with said base unit and said processor; and wherein said radio device further includes:
an interface for receiving a personal music player;
a strobe light; and
a cup holder.

18. (canceled)

19. (canceled)

20. The method of claim 11, wherein said radio device further includes:
an interface for receiving a personal music player;
a strobe light; and
a cup holder.

21. The method of claim 11 wherein:
said first stop event is not manual; and
said next stop event is not manual.

22. The method of claim 11, wherein said first stop event is movement of said radio device outside an approved geographic area.

23. The method of claim 11, wherein said next stop event is movement of said radio device outside an approved geographic area.
